(19) United States
(12) Patent Application Publication
(10) Pub. No.: US 2018/0043566 A1
(43) Pub. Date: Feb. 15, 2018

(54) GUIDE BAR WITH INTERNAL CAVITY

(71) Applicant: HUSQVARNA AB, HUSKVARNA (SE)

(72) Inventors: Christian Liliegård, Jönköping (SE); Per Söderlind, Jönköping (SE)

(21) Appl. No.: 15/554,799

(22) PCT Filed: Mar. 4, 2016
(86) PCT No.: PCT/IB2016/051236

§ 371 Date: Aug. 31, 2017

Related U.S. Application Data
(60) Provisional application No. 62/127,905, filed on Mar. 4, 2015.

(51) Int. Cl. B27B 17/02; B27B 17/12

(52) U.S. Cl. CPC B27B 17/025; B27B 17/12

(57) ABSTRACT

A chainsaw (100) includes a power unit and a working assembly powered responsive to operation of the power unit. The working assembly includes a guide bar (120) around which a chain is rotatable. The guide bar (120) includes first and second side plates (200, 210) and a laminate core (260). The guide bar (120) is configured to deliver water through at least a portion of the guide bar (120). The first and second side plates (200, 210) each face other and extend away from a housing (110) to a nose. The laminate core (260) is disposed between the first side plate (200) and the second side plate (210). The laminate core (260) includes channels (270) for delivery of the water to nozzles (300, 310, 320) formed along a periphery of the guide bar (120). A glue layer (280) is provided to affix the laminate core (260) to the first side plate (200) and second side plate (210), respectively. The glue layer (280) forms the nozzles (300, 310, 320) in combination with the laminate core (260).

### CROSS REFERENCE TO RELATED APPLICATION

This application claims priority to U.S. provisional application No. 62/127,905 filed on Mar. 4, 2015, the entire contents of which are incorporated herein by reference.

### TECHNICAL FIELD

Example embodiments generally relate to hand held power equipment and, more particularly, relate to a guide bar improvements for a chainsaw.

### BACKGROUND

Chainsaws are commonly used in both commercial and private settings to cut timber or perform other rigorous cutting operations. Because chainsaws are typically employed in outdoor environments, and the work they are employed to perform often inherently generates debris, chainsaws are typically relatively robust hand held machines. They can be powered by gasoline engines or electric motors (e.g., via batteries or wired connections) to turn a chain around a guide bar at relatively high speeds. The chain includes cutting teeth that engage lumber or another medium in order to cut the medium as the teeth are passed over a surface of the medium at high speed.

Given that the chainsaw may be employed to cut media of various types of media, it may be appreciated that different sizes and configurations of chainsaw may be desirable. However, particularly when the media to be cut is concrete, masonry, or other very hard materials, the typical chainsaw (and corresponding construction) cannot be employed. The heat generated by cutting hard media and the amount of dust and debris accumulating at the cutting components may damage components of the chainsaw. To enable such cutting, water may be provided to the cutting zone.

Accordingly, it may be desirable to consider water transport and delivery methods in relation to design and operation of certain chainsaws. Moreover, it may be desirable to design the guide bar to facilitate such water transport and delivery.

### BRIEF SUMMARY OF SOME EXAMPLES

Some example embodiments may provide for a guide bar constructed with laminate cores that can be glued, welded or otherwise fixed together to incorporate various improvements. In some cases, the glue itself may be used to form water channels and/or nozzles to allow water to be distributed at the chain for cutting certain media (e.g., concrete). Other improvements may also be possible, and the improvements can be made completely independent of each other, or in combination with each other in any desirable configuration. Accordingly, the operability and utility of the chainsaw may be enhanced or otherwise facilitated.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a chainsaw according to an example embodiment;

FIG. 2 illustrates a perspective view of an axial end (e.g., a forward portion or nose) of the guide bar of FIG. 1 in accordance with an example embodiment;

FIG. 3 illustrates an exploded perspective view of the axial end of the guide bar from the same perspective shown in FIG. 2 in accordance with an example embodiment;

FIG. 4 illustrates a side view of the guide bar with one side plate removed to expose water channels formed in accordance with an example embodiment; and

FIG. 5 illustrates a cutaway side view of a spray nozzle in accordance with an example embodiment;

FIG. 6 illustrates a cutaway side view of a rinse nozzle in accordance with an example embodiment; and

FIG. 7 illustrates a cutaway side view of a jet nozzle in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Guide bars may be made of laminated bars that are spot welded together. When cutting concrete and/or the like, the guide bars may be configured to include water channels therein. As an example, to transport water to the cutting zone for cooling and waste transport, the water channels may be formed between the laminated bars. In some cases, the laminated bars may be formed by laser cutting or stamping. However, to form the channels and/or nozzles for water delivery, extra machining of the laminated bars may be required. Moreover, it may be difficult to employ design features such as providing specific spray patterns for the nozzles in such a context. Accordingly, example embodiments may be provided to employ plates that can be glued together (e.g., instead of being welded). Moreover, the glue can be used to form channels and control how water flows in the channels. As such, the glue can actually be used to interact with the plates and channels to create nozzles having specific desired water delivery characteristics.

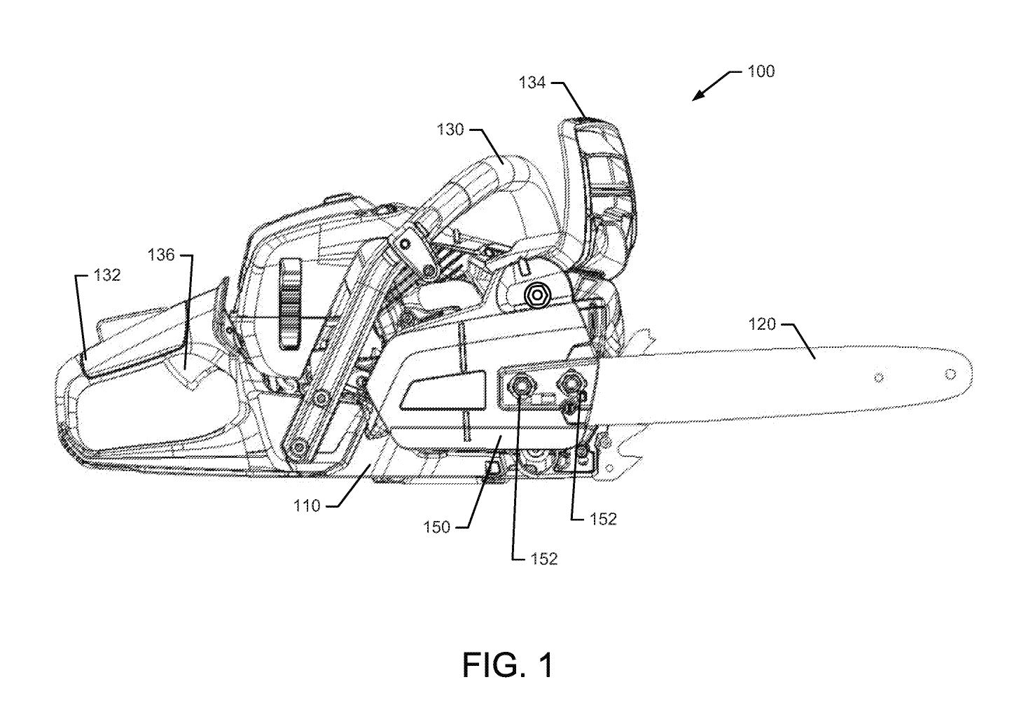

FIG. 1 illustrates side view of a chainsaw 100 according to an example embodiment. As shown in FIG. 1, the chainsaw 100 may include a housing 110 inside which a power unit or motor (not shown) is housed. In some embodiments, the power unit may be either an electric motor or an internal combustion engine. Furthermore, in some embodiments, the power unit may include more than one electric motor where one such electric motor powers the working assembly of the chainsaw 100 and the other electric motor of the power unit powers a pump that lubricates the working assembly or provides momentum for moving other working fluids within the chainsaw 100. The chainsaw 100 may further include a guide bar 120 that is attached to the housing 110 along one side thereof. A chain (not shown) may be driven around the guide bar 120 responsive to operation of the power unit in order to enable the chainsaw 100 to cut concrete or other materials. As such, the chain may be, for example, a diamond chain. The guide bar 120 and the chain may form the working assembly of the chainsaw 100. As such, the power unit may be operably coupled to the working assembly to turn the chain around the guide bar 120.

The chainsaw 100 may include a front handle 130 and a rear handle 132. A chain brake and front hand guard 134 may be positioned forward of the front handle 130 to stop the movement of the chain 122 in the event of a kickback. In an example embodiment, the hand guard 134 may be tripped by rotating forward in response to contact with a portion of the arm (e.g., the hand/wrist) of the operator of the chainsaw 100. In some cases, the hand guard 134 may also be tripped in response to detection of inertial measurements indicative of a kickback.

The rear handle 132 may include a trigger 136 to facilitate operation of the power unit when the trigger 136 is actuated. In this regard, for example, when the trigger 136 is actuated (e.g., depressed), the rotating forces generated by the power unit may be coupled to the chain either directly (e.g., for electric motors) or indirectly (e.g., for gasoline engines). The term “trigger,” as used herein, should be understood to represent any actuator that is capable of being operated by a hand or finger of the user. Thus, the trigger 136 may represent a button, switch, or other such component that can be actuated by a hand or portion thereof.

Some power units may employ a clutch to provide operable coupling of the power unit to a sprocket that turns the chain. In some cases (e.g., for a gasoline engine), if the trigger 136 is released, the engine may idle and application of power from the power unit to turn the chain may be stopped. In other cases (e.g., for electric motors), releasing the trigger 136 may secure operation of the power unit. The housing 110 may include a fuel tank for providing fuel to the power unit. The housing 110 may also include or at least partially define an oil reservoir, access to which may be provided to allow the operator to pour oil into the oil reservoir. The oil in the oil reservoir may be used to lubricate the chain as the chain is turned.

As can be appreciated from the description above, actuation of the trigger 136 may initiate movement of the chain around the guide bar 120. A clutch cover 150 may be provided to secure the guide bar 120 to the housing 110 and cover over the clutch and corresponding components that couple the power unit to the chain (e.g., the sprocket and clutch drum). As shown in FIG. 1, the clutch cover 150 may be attached to the body of the chainsaw 100 (e.g., the housing 110) via nuts 152 that may be attached to studs that pass through a portion of the guide bar 120. The guide bar 120 may also be secured with the tightening of the nuts 152, and a tightness of the chain can be adjusted based on movement of the guide bar 120 and subsequent tightening of the nuts 152 when the desired chain tightness is achieved. However, other mechanisms for attachment of the clutch cover 150 and/or the guide bar 120 may be provided in other embodiments including, for example, some tightening mechanisms that may combine to tighten the chain in connection with clamping the guide bar 120.

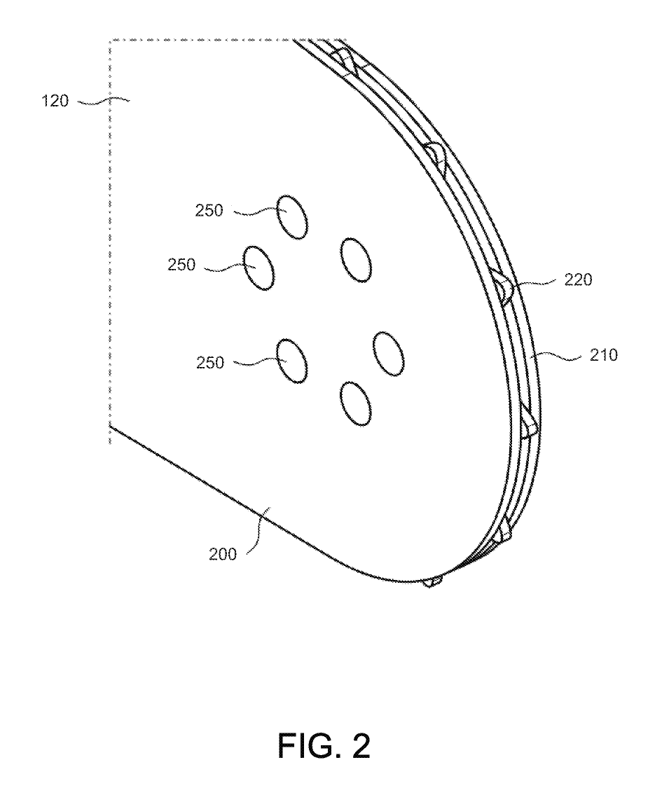

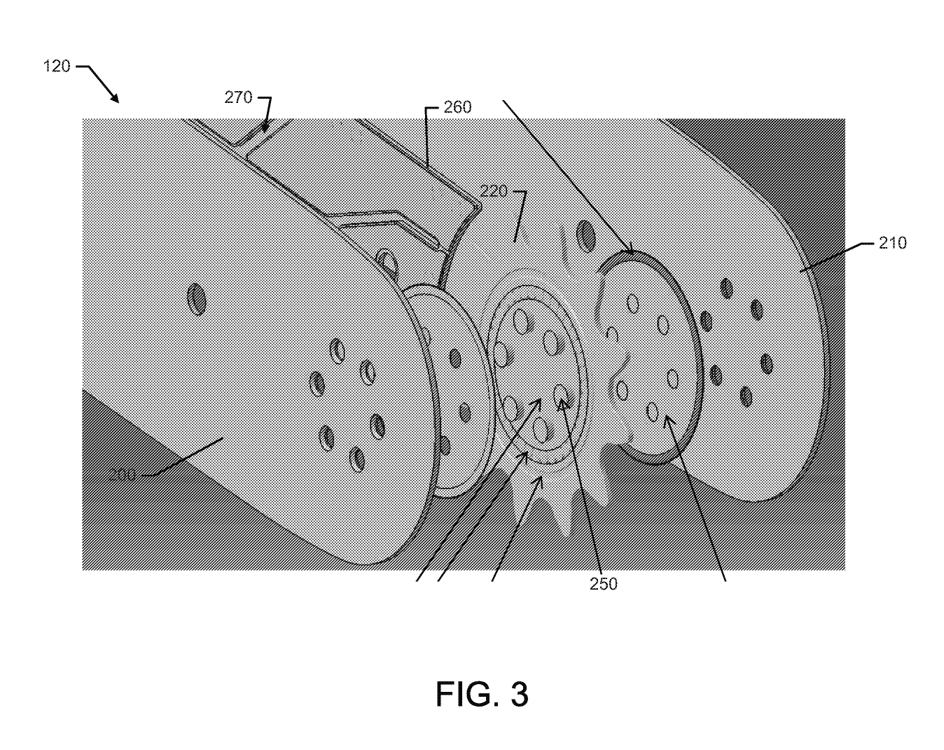

As mentioned above, the guide bar 120 may be formed from two laminated sheets that lie in parallel planes along side each other, with a laminate core provided therebetween. These laminated sheets may be made from stainless steel or other sufficiently rigid and durable materials. The outer laminated sheets may be referred to herein as a first side plate 200 and a second side plate 210, respectively. The first and second side plates 200 and 210, which can be seen in FIG. 2, may generally be spaced apart from each other be at least a certain distance, which may be substantially consistent over the lengths of the first and second side plates 200 and 210. The laminate core 260 (see FIG. 3) may define the space between the first and second side plates 200 and 210. In some embodiments, a sprocket wheel 220 may be provided in the space between the first and second side plates 200 and 210 at a distal end, or nose of the guide bar 120. The sprocket wheel 220 may be rotatable to interface with the cutting chain as the cutting chain turns around the axial end of the guide bar 120.

Rivets 250 may be provided to fix the sprocket wheel 220 and the first and second side plates 200 and 210 together. As such, receiving holes may be formed and aligned in each of these components and the rivets 250 may pass through the aligned receiving holes to hold the entire assembly together. As the rivets 250 bind the first and second side plates 200 and 210 together, the first and second side plates 200 and 210 may bind the laminate core 260 therebetween. As mentioned above, the laminate core 260 may, in some cases, have channels 270 formed therein. The laminate core 260 may therefore have portions thereof that are etched, machined, laser cut, or are otherwise formed or provided with the channels 270 provided therein. Responsive to connection of the chainsaw 100 to an external pressurized water source (e.g., a water hose connected to a spigot), water may be ported through the channels 270 for application to the chain as the chain rotates around the guide bar 120.

However, in accordance with an example embodiment, rather than spot welding the first and second side plates 200 and 210 together, a glue layer 280 may be provided on each side of the laminate core 260 to facilitate affixing the laminate core 260 and the first and second side plates 200 and 210. The glue layer 280 may also seal against water penetration and further define the channels 270. As such, portions of the channels 270 may be defined by a combination of the first and second side plates 200 and 210, the laminate core 260, and the glue layers 280.

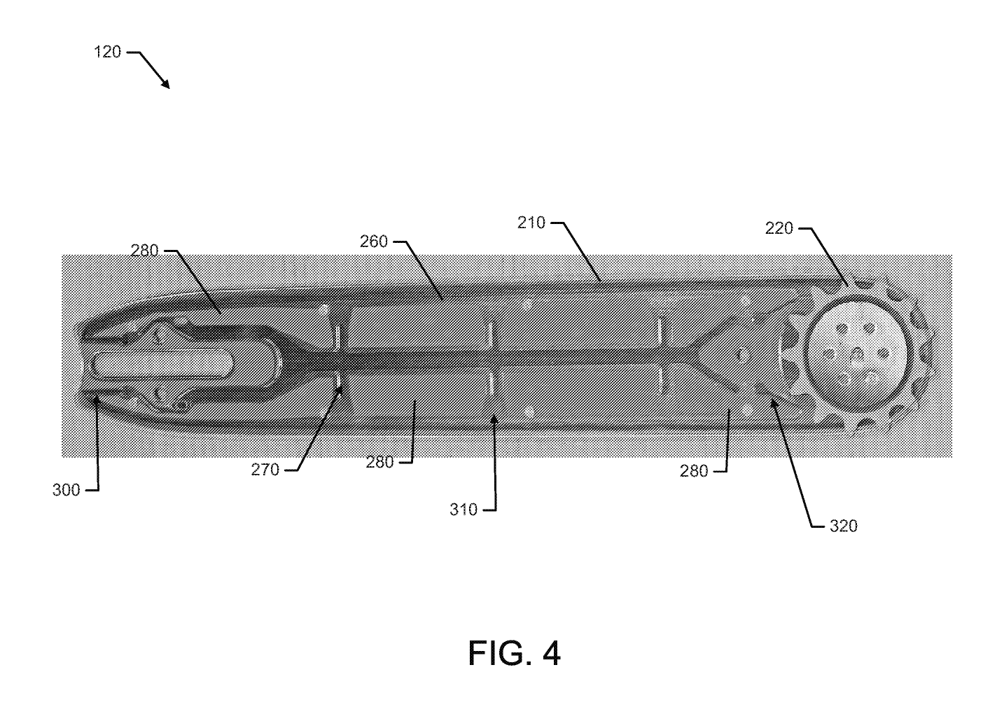

FIG. 4 illustrates a side view of the guide bar 120 with the first side plate 200 removed. The laminate core 260 and the sprocket wheel 220 are therefore exposed. The glue layer 280 between the laminate core 260 and the first side plate 200 is also exposed. As can be appreciated from FIG. 4, the glue layer 280 may be discontinuous at certain portions, since the channels 270 may divide the laminate core 260 into separate regions at which the glue layer 280 may be formed. It should also be appreciated that another glue layer also exists, but is not visible in FIG. 4, between the second side plate 220 and the laminate core 260 and the glue layer that is not visible may substantially mirror the glue layer 280 shown.

As mentioned above, the glue layer 280 may be used to facilitate formation of the channels 270, and may also allow different nozzle types to be implemented without the need for complicated machining, etching or laser cutting. Thus, for example, spray nozzles, rinse nozzles and jet nozzles may be provided at desirable locations where the channels 270 terminate proximate to the chain. The glue layer 280 may therefore interface with the channels 270 at ejection ports formed to allow water to exit the channels 270 toward the chain. The ejection ports may have geometries that are formed at least in part based on the application of the glue layer 280 proximate to (and in some cases on opposing sides of) the ejection ports. The glue layer 280 can therefore tailor or at least directly impact water ejection or delivery characteristics of the ejection ports to form different nozzle types.

In the example of FIG. 4, a spray nozzle 300 is shown proximate to the heel of the guide bar 120. The spray nozzle 300 may be effectively employed to provide cooling and debris removal proximate to the drive sprocket (not shown), which may actually turn the chain. In some cases, a rinse nozzle 310 may be formed along middle portions of the guide bar 120 (e.g., between the heel and the nose) to rinse debris out of the chain, while also providing some cooling. Meanwhile, a jet nozzle 320 may be provided proximate to the sprocket wheel 220. The jet nozzle 320 may be formed to generate increased water pressure since this region is closest to the cutting zone. The jet nozzle 320 may therefore be important for cooling proximate to the sprocket wheel 220 and for facilitating ejection or repelling of debris from the chain and cooling of the chain at this dirtiest and hottest part of the guide bar 120.

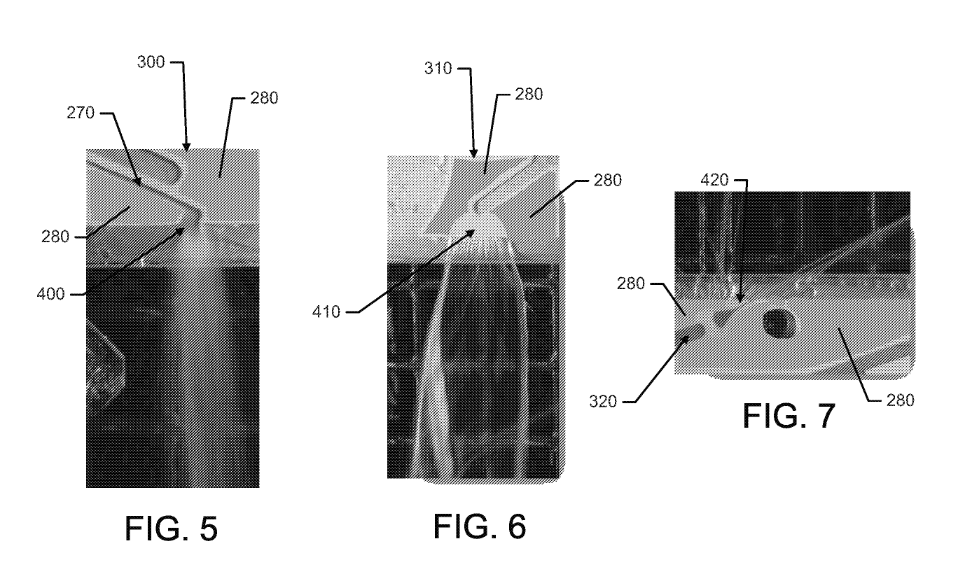

FIG. 5 illustrates a closer view of the spray nozzle 300 in accordance with an example embodiment. As shown in FIG. 5, water may pass through channel 270 toward the ejection port 400. However, the glue layer 280 provided on each side of the ejection port 400 may, by virtue of the glue layer's waterproof nature, further impacts the water dispensing characteristics of the ejection port 400 to form the ejection port 400 into spray nozzle 300. Of note, the spray nozzle 300 can be provided at the heel since glue will be less likely to leak than a welded assembly. Thus, components in the housing 110 may be less likely to see any negative impact from exposure to water, since there is likely to be less leakage, and water will instead be directed more efficiently onto the chain for cleaning and cooling. The water may also reach the chain as the chain leaves the guide bar 120 to contact the drive sprocket. At this point, the chain is more accessible or “out in the open,” so it is a good time to apply water to improve the effectiveness of both cooling and cleaning.

FIG. 6 illustrates a closer view of the rinse nozzle 310, several of which may be provided along middle portions of the guide bar 120. Again, the channel 270 may be formed to lead water toward ejection port 410. The glue layer 280 may again be provided on each side of the ejection port 410 to further impact the water dispensing characteristics of the ejection port 410 to form the ejection port 410 into rinse nozzle 310.

FIG. 7 illustrates a closer view of the jet nozzle 320 in accordance with an example embodiment. As shown in FIG. 7, water may pass through channel 270 toward the ejection port 420. However, the glue layer 280 provided on each side of the ejection port 420 may further impact the water dispensing characteristics of the ejection port 420 to form the ejection port 420 into jet nozzle 320. Of note, the jet nozzle 320 can be provided at the nose and proximate to the sprocket wheel 200 to clean and cool the chain nearest the source of heat and debris generation.

For at least some of the nozzles, water may pass through the channel 270 toward the corresponding ejection port, but may pass on both sides of the laminate core 260 in the nozzle area. This further gives the opportunity to spray and clean both sides of the chain. As such, for at least some nozzles, the nozzle is formed by the gap that the glue layer 280 forms between the laminate core 260 and the closest one of the side plates. Moreover, the nozzle is formed as two separate gaps on opposing sides of the laminate core 260. Accordingly, the nozzle can be formed without any machining.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A chainsaw comprising:
a power unit disposed in a housing; and
a working assembly powered responsive to operation of the power unit, the working assembly comprising a guide bar around which a chain is rotatable, the guide bar being configured to deliver water through at least a portion of the guide bar,
wherein the guide bar comprises:
a first side plate and a second side plate facing each other and extending away from the housing to a nose of the guide bar; and
a laminate core disposed between the first side plate and the second side plate,
wherein the laminate core comprises channels for delivery of the water to nozzles formed along a periphery of the guide bar, and
wherein a glue layer is provided to affix the laminate core to the first side plate respectively, and the glue layer forms the nozzles in combination with the laminate core.

2. The chainsaw of claim 1, wherein the nozzles are formed at ejection ports formed proximate to where the channels terminate such that the nozzles allow water to pass on opposing sides of the laminate core at the ejection ports.

3. The chainsaw of claim 1, wherein at least one nozzle is provided proximate to a heel of the guide bar.

4. The chainsaw of claim 3, wherein the at least one nozzle is formed as a spray nozzle.

5. The chainsaw of claim 1, wherein at least one nozzle is provided between a heel and a nose of the guide bar.

6. The chainsaw of claim 5, wherein the at least one nozzle is formed as a rinse nozzle.

7. The chainsaw of claim 1, wherein at least one nozzle is provided proximate to a nose of the guide bar.

8. The chainsaw of claim 7, wherein the at least one nozzle is formed as a jet nozzle.

9. A guide bar for guiding a chain of a chainsaw, the guide bar comprising:
a first side plate and a second side plate facing each other and extending away from a housing to a nose of the guide bar; and
a laminate core disposed between the first side plate and the second side plate,
wherein the laminate core comprises channels for delivery of the water to nozzles formed along a periphery of the guide bar, and
wherein a glue layer is provided to affix the laminate core to the first side plate and the second side plate, respectively, and the glue layer forms the nozzles in combination with the laminate core.

10. The guide bar of claim 9, wherein the nozzles are formed at ejection ports formed proximate to where the channels terminate such that the nozzles allow water to pass on opposing sides of the laminate core at the ejection ports.

11. The guide bar of claim 9, wherein at least one nozzle is provided proximate to a heel of the guide bar.

12. The guide bar of claim 11, wherein the at least one nozzle is formed as a spray nozzle.

13. The guide bar of claim 9, wherein at least one nozzle is provided between a heel and a nose of the guide bar.

14. The guide bar of claim 13, wherein the at least one nozzle is formed as a rinse nozzle.

15. The guide bar of claim 9, wherein at least one nozzle is provided proximate to a nose of the guide bar.

16. The guide bar of claim 15, wherein the at least one nozzle is formed as a jet nozzle.
